(19) United States
(12) Patent Application Publication
(10) Pub. No.: US 2026/0362066 A1
(43) Pub. Date: Nov. 12, 2026

(54) Wind noise reduction with hearing device

(71) Applicant: SONOVA AG, Staefa (CH)

(72) Inventors: Michael Kramer, Urbana, IL (US); Samuel Bucher, Rapperswil (CH); Andreas Kreuzmann, Männedorf (CH); Gregor Ochsner, Einsiedeln (CH); Jan Brunner, Stäfa (CH); Laura Jagoda, Zurich (CH); Nele Börsing, Stäfa (CH)

(21) Appl. No.: 19/203,534

(22) Filed: May 9, 2025

(51) Int. Cl. H04R 25/00

(52) U.S. Cl. CPC H04R 25/502; H04R 2410/07

(57) ABSTRACT

A method for wind noise reduction with a hearing device comprises: receiving a first input signal from a first microphone of the hearing device and a second input signal from a second microphone of the hearing device; determining correlated components of the first input signal and the second input signal; and determining a noise reduced signal by dampening components in the first input signal different from the correlated components and/or by amplifying the correlated components in the first input signal.

### BACKGROUND INFORMATION

Hearing devices may be used for compensating hearing deficiencies of a user and may provide several features that aim to facilitate speech intelligibility, improve sound quality, reduce noise level or adjust general volume. Many functionalities are designed to benefit the user's hearing performance in very specific situations.

Wearing hearing devices in an outside environment can cause the input signals from the microphones to be masked by wind noise, which affects the perceptibility of target signals such as speech. The wind noise is dominantly from air pressure fluctuations on the microphones caused by local air turbulences around the hearing device. Usually, wind noise is dominant in frequencies below 1500 Hz.

Some hearing devices provide a wind noise canceller, which comprises a wind noise detector and a static high-pass filter. The wind noise detector determines, when wind noise cancelling should be enabled, and the static high-pass filter then suppresses low frequency signals presumed to be dominated by noise. While this is a simple and effective solution, it may also affect target signals in their low frequencies and does not provide any noise cancelling benefit above the cutoff frequency.

Alternative solutions may be based on comparing the wind noise presence on two microphones of the hearing device and selecting the input signal which contains less wind noise.

### BRIEF DESCRIPTION OF THE DRAWINGS

Below, embodiments are described in more detail with reference to the attached drawings.

FIG. 1 schematically shows a hearing device.

FIG. 2 schematically shows a functional diagram of a hearing device according to an embodiment.

FIGS. 3 and 4 show diagrams with auto-correlations and cross-correlations of input signals.

FIG. 5 shows a diagram with coherences during speech and wind noise.

FIGS. 6 and 7 show diagrams with an averaged power ratio of the input signals during speech and wind noise.

The reference symbols used in the drawings, and their meanings, are listed in summary form in the list of reference symbols. In principle, identical parts are provided with the same reference symbols in the figures.

### DETAILED DESCRIPTION

Described herein are a method, computer program and computer-readable medium for wind noise reduction with a hearing device as well as to the hearing device.

It is a feature described herein to reduce a wind noise signal in an input signal of a hearing device. It is a further feature to increase speech understandability for hearing device users in windy situations.

A first aspect relates to a method for wind noise reduction with a hearing device. In general, a hearing device is adapted for receiving one or more audio signals, processing the one or more audio signals into a processed audio signal and outputting the processed audio signal to a user, i.e., the user wearing the hearing device. The one or more audio signals may be provided by microphones of the hearing device. The processed audio signal may be output by a loudspeaker of the hearing device, which also may be called receiver. The hearing device may be a hearing aid, which is a hearing device adapted for processing the one or more audio signals, such that a hearing loss of the user is compensated.

According to an embodiment, the method comprises: receiving a first input signal from a first microphone of the hearing device and a second input signal from a second microphone of the hearing device. The first microphone and the second microphone may be integrated into one housing of the hearing device. The input signals are audio signals and, when digitized, may be considered as audio streams, which may be digital data streams. Digital data streams comprise data, such as audio data, wherein the data values are associated with time values. The data values are timely ordered. All signals mentioned below may be considered as such data streams.

According to an embodiment, the method comprises: determining correlated components of the first input signal and the second input signal. The first microphone and the second microphone acquire sound of sound sources around the user. When exposed to wind, each microphone may acquire wind noise, however, the wind noise acquired by the first microphone and the wind noise acquired by the second microphone is usually weakly correlated. Therefore, it is assumed that the correlated components of the first input signal and the second input signal are primarily from the desired sound sources. It follows that when components different from the correlated components are dampened, mainly wind noise is dampened in the respective input signal. Also, when the correlated components in the first input signal are amplified, then the desired sound sources are correspondingly amplified. The components may be frequency ranges and/or frequency bins of the respective input signal.

The term component may refer to a frequency component and/or a frequency band of the respective input signal.

A noise reduced signal, which is further processed by the hearing device, may be determined from the first input signal or the second input signal.

According to an embodiment, the method comprises: determining a first noise reduced signal by dampening components in the first input signal different from the correlated components and/or by amplifying the correlated components in the first input signal. In particular, frequency ranges and/or frequency bins of the respective input signal may be damped. This may mean that the amplitude of the signal in the frequency range and/or frequency bin is reduced.

According to an embodiment, the method comprises: determining a second noise reduced signal by dampening components in the second input signal different from the correlated components and/or by amplifying the correlated components in the second input signal. The components in the second input signal different from the correlated components may be uncorrelated components.

According to an embodiment, the method comprises: determining a mixed noise reduced signal by mixing the first noise reduced signal and the second noise reduced signal. As a further possibility the noise reduced signal, which is further processed by the hearing device, is a mixture of the first noise reduced signal and the second noise reduced signal. Mixing may be performed by analyzing, which input signal contains lesser wind noise than the other signal and higher weighting the noise signal corresponding to the input signal with lesser wind noise.

According to an embodiment, the method comprises: determining a first auto-correlation of the first input signal, a second auto-correlation of the second input signal and a cross-correlation between the first input signal and the second input signal.

In general, a correlation may be determined by multiplication of the signal with itself (for auto-correlation) or by multiplication of the signals (for cross-correlation) in the frequency domain. The result may be smoothed by averaging. The input signals may be complex-valued signals. The cross-correlation may be the expectation value of the first input signal times the conjugate complex second input signal. The auto-correlation of an input signal may be the value of the square of the absolute value of the input signal. The auto-correlation may be real-valued. The cross-correlation may be complex-valued.

According to an embodiment, the first input signal and second input signal are transformed into the frequency domain. After the transformation, each input signal may be a complex-valued signal, which is composed of Fourier components of the input signal in the time domain.

According to an embodiment, the cross-correlation, the first auto-correlation and the second auto-correlation may be determined in the frequency domain. The cross-correlation, the first auto-correlation and the second auto-correlation may be determined per frequency band and/or frequency bin. There may be a cross-correlation, a first auto-correlation and a second auto-correlation for a plurality of frequency bands.

According to an embodiment, the cross-correlation, the first auto-correlation and second auto-correlation are averaged in the frequency domain.

According to an embodiment, the method comprises: determining a transfer function by dividing the cross-correlation by a weighted sum of the first auto-correlation and the second auto-correlation. The transfer function may be determined per frequency band and/or frequency bin. There may be a transfer function for a plurality of frequency bands.

According to an embodiment, the weighted sum of the first auto-correlation and the second auto-correlation is determined by multiplying the first auto-correlation with a first regularization coefficient and the second auto-correlation with a second regularization coefficient. With these regularization coefficients, the wind noise suppression can be tuned.

The transfer function may be seen as a quantity from which the correlated components may be derived. A magnitude of the complex-valued transfer function may provide a gain, which is higher for strongly correlated components and which is lower for weaker correlated components of the input signals.

Furthermore, a phase of the transfer function provides a phase response from the second microphone to the first microphone. The phase response may transform the second input signal to a signal, which can be compared with the first input signal.

According to an embodiment, the method comprises: determining a noise reduced signal by multiplying the first input signal and/or the second input signal with the transfer function or at least with a magnitude of the transfer function. In such a way, correlated components are amplified and uncorrelated components, i.e., components different from the correlated components, are dampened. Multiplication may be performed by frequency band.

According to an embodiment, a magnitude of the transfer function is limited from below with a minimal gain before multiplication with the first input signal and/or the second input signal. To reduce artifacts, magnitudes, which are below a threshold, i.e., the minimal gain, are set to the minimal gain.

According to an embodiment, a magnitude of the transfer function is limited from above with a maximal gain before multiplication with the first input signal and/or the second input signal. To reduce artifacts, magnitudes, which are above a threshold, i.e., the maximal gain, are set to the maximal gain. The maximal gain may be 1. In such a way, there is no amplification and solely not related components are dampened.

According to an embodiment, the method comprises: determining a first noise reduced signal by multiplying the first input signal with the transfer function, wherein a magnitude of the transfer function is limited from below with a minimal gain and limit from above with a maximal gain before multiplication with the second input signal. The first noise reduced signal may be based solely on dampening not correlated components.

According to an embodiment, the method comprises: determining a second noise reduced signal by multiplying the second input signal with the transfer function, wherein a magnitude of the transfer function is limited from below with a minimal gain. The first noise reduced signal may be based on dampening not correlated components and amplification of correlated components.

According to an embodiment, the method comprises: mixing the first noise reduced signal and the second noise reduced signal by: determining weights for the first noise reduced signal and the second noise reduced signal, and summing the first noise reduced signal and the second noise reduced signal weighted with the weights. The weights may be determined based on an analysis with respect to the amount of wind noise in the respective input signal and/or when there are signs of clipping in the respective signal. The lower the signal quality, the smaller the corresponding weight.

According to an embodiment, a first power of the first input signal in at least a frequency band and a second power of the second input signal in at least the frequency band are determined. The amount of wind noise may be determined from the first power and the second power. The first power and the second power may be determined over time. The frequency band may be the complete frequency range of the input signals or may be a band of one or a plurality of frequency bins.

According to an embodiment, a power ratio is determined from the first power and the second power, for example dividing the second power by the first power or vice versa. The weights may be determined from the power ratio. The power ratio may be an indicator at which microphone the wind noise is higher compared to the other microphone. The weights may be chosen, such that the signal with the higher wind noise is damped and the signal with the lower wind noise is amplified.

The weights may be 0 and 1, i.e. either the first noise reduced signal or the second noise reduced signal may be used as output signal.

According to an embodiment, the power ratio is averaged into an averaged power ratio, in particular with dual slope averaging, and the weights are determined from the averaged power ratio. The peaks of the power ratio may be tracked, for example by dual slope averaging. From the number and/or magnitude of the peaks, the weights may be determined. For example, when the average power ratio is higher as a threshold, the weight for first noise reduced signal may be chosen to be 1 (or alternatively 0) and the weight for the second noise reduced signal may be chosen to be 0 (or alternatively 1).

According to an embodiment, the first microphone is a front microphone and the second microphone is a back microphone of the hearing device. The hearing device may comprise a behind-the-ear part and an in-the-ear part. When worn by the user, the behind-the-ear part is located behind an ear of the user and the in-the-ear part is located inside the ear of the user. The first microphone and the second microphone may be integrated into a housing of the behind-the-ear part. The front microphone may be arranged in a top region of the behind-the-ear part. The back microphone may be arranged in a back region of the behind-the-ear part. The orientations top and back are understood with respect to the head of the user, when the hearing device is worn by the user.

According to an embodiment, the method comprises: further processing the noise reduced signal or the mixed noise reduced signal into a further processed signal. This may be performed with a sound processor of the hearing device, which may comprise one or more actuators. The actuators may be provided by software and/or hardware, such as a DSP, a processor, etc.

According to an embodiment, the method comprises: outputting the further processed signal to a user of the hearing device. The processed audio stream may be output by a loudspeaker, which may be arranged in an ear channel of the user.

According to an embodiment, the further processing comprises at least one of and/or the actuators are adapted for at least one of: frequency depending amplification, frequency shifting, frequency compressing, beam forming, noise cancelling.

A further aspect relates to a computer program for wind noise reduction with a hearing device, which, when being executed by at least one processor, is adapted to carry out the steps of the method such as described herein. For example, the computer program may be executed in the hearing device.

A further aspect relates to a computer-readable medium, in which such a computer program is stored. In general, a computer-readable medium may be a hard disk, a USB (Universal Serial Bus) storage device, a RAM (Random Access Memory), a ROM (Read Only Memory), an EPROM (Erasable Programmable Read Only Memory) or a FLASH memory. A computer-readable medium may also be a data communication network, e.g., the Internet, which allows downloading a program code. The computer-readable medium may be a non-transitory or transitory medium. The computer-readable medium may be a memory of the hearing device.

A further aspect relates to a hearing device with a first microphone, a second microphone, a sound output device, a wind noise canceller and a sound processor. The first microphone, the second microphone, the sound output device, the wind noise canceller and the sound processor may be integrated in a housing of the hearing device. The sound output device, such as a loudspeaker, may be integrated into the housing or may be connected via a cable with the housing. The hearing device is adapted for performing the method such as described herein.

It has to be understood that features of the method as described in the above and in the following may be features of the hearing device, computer program and the computer-readable medium as described in the above and in the following, and vice versa.

These and other aspects will be apparent from and elucidated with reference to the embodiments described hereinafter.

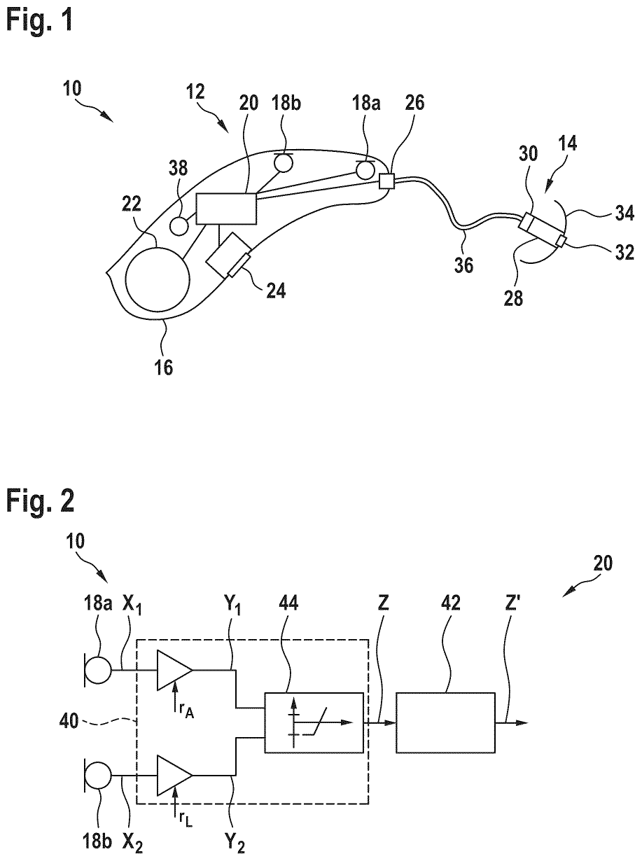

FIG. 1 shows a hearing device 10, in particular a hearing aid, which is composed of a behind-the-ear part 12 and an in-the-ear part 14.

The behind-the-ear part 12 has a housing 16 adapted to be carried behind the ear of a user. Two microphones 18a, 18b, a computing device 20, a battery 22, a knob 24 and a connector 26 are integrated into the housing 16. A front microphone 18a is located at a position of the housing 16 to be more exposed to sound received from a front direction of the user. A back microphone 18b is located at a position of the housing 16 to be more exposed to sound received from a back direction of the user. The computing device 20 is powered by the battery 22 and/or comprises a software processor, a signal processor and a memory. The knob can be actuated by a user and/or be used as user interface for switching the hearing device 10 on and off and for optionally changing settings of the hearing device 10.

The in-the-ear part 14 comprises a housing 28 adapted to be plugged into the ear channel of the user. A connector 30 and sound output device 32, like a loudspeaker and/or receiver, are integrated into the housing 28. The housing 28 comprises a dome 34 for occluding the ear channel. The in-the-ear part 14 is connected via a cable 36 with the behind-the-ear part 12, which cable 36 is connected to the connectors 26, 30.

There may be one or more further sensors 38, such as an acceleration sensor or health sensor, integrated into the housing 16.

The hearing device 10 acquires an audio input signal with each of the microphones 18a, 18b from an environment of the user. The computing device 20 processes the input signals into a processed audio signal, which is provided via the cable 36 to the sound output device 32 and output to the user.

FIG. 2 shows a functional diagram of the hearing device 10. Also a method performed by the hearing device 10 and in particular the computing device 20 will be described with respect to FIG. 2.

It is shown that the computing device 20 comprises a wind noise canceller 40 and a sound processor 42.

The wind noise canceller 40 receives a first input signal X₁ from the microphone 18a of the hearing device 10 and a second input signal X₂ from the microphone 18b of the hearing device 10. The wind noise canceller 40 uses both the front microphone 18a and the back microphone 18b and processes their input signals X₁, X₂. In general, input signals X₁, X₂ from at least two acoustically separated microphones 18a, 18b are used for signal analysis and filtering.

The time domain input signals X₁, X₂ from the microphones 18a, 18b are converted in the frequency domain resulting in a first input signal X₁ in the frequency domain from the front microphone 18a and second input signal X₂ in the frequency domain from the back microphone 18b. Both input signals X₁, X₂ can be seen as vectors composed of complex values, which may be seen as Fourier coefficients of the time domain signals.

The following processing of the input signals X₁, X₂ is done in the frequency domain. It is possible that the processing is done in separate sub-bands. In general, the processing may be done broadband or based on a plurality of frequency bands.

At next, the wind noise canceller 40 analyzes the correlation of the input signals X₁, X₂ of the two microphones 18a, 18b of the hearing device 10 to determine and remove wind noise components of the input signals X₁, X₂, while retaining the desired speech.

The wind noise canceller 40 determines correlated components of the first input signal X₁ and the second input signal X₂. After that, the wind noise canceller 40 determines a first noise reduced signal Y₁ by dampening components in the first input signal X₁ different from the correlated components and/or by amplifying the correlated components in the first input signal X₁. The wind noise canceller 40 further determines a second noise reduced signal Y₂ by dampening components in the second input signal X₂ different from the correlated components and/or by amplifying the correlated components in the second input signal X₂.

To this end, a cross-correlation

$$E [ {X}_{1} {X}_{2}^{*} ]$$

of the two signals X₁, X₂, a first auto-correlation E[|X₁|²] of the first input signal X₁ and a second auto-correlation E[|X₂|²] of the second input signal X₂ are calculated. The function E[X] denotes the expectation value of the vector X. However, it is possible that the calculation of the expectation value E[X] is replaced by a calculation of an average value, which determines the average of the vector X. The cross-correlation

$$E [ {X}_{1} {X}_{2}^{*} ] ,$$

the first auto-correlation E[|X₁|²] and second auto-correlation E[|X₂|²] may be determined by averaging in the frequency domain.

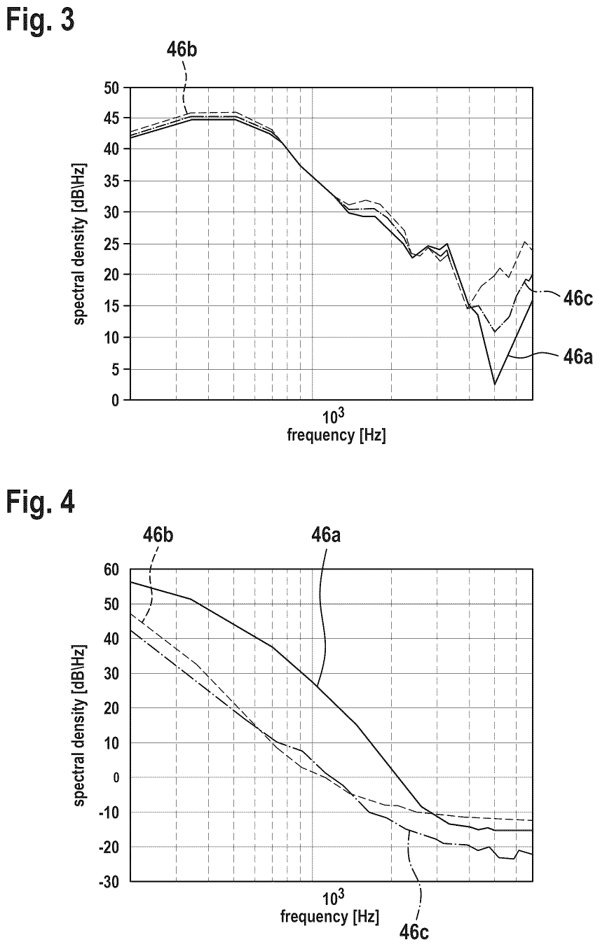

FIGS. 3 and 4 shows auto-correlations 46a, 46b and cross-correlations 46c of the input signals X₁, X₂ of the microphones during speech (FIG. 3) and during wind noise (FIG. 4).

The curve 46a shows the first auto-correlation E[|X₁|²] of the first input signal X₁ with respect to the frequency. The curve 46b shows the second auto-correlation E[|X₂|²] of the second input signal X₂ with respect to the frequency. The curve 46c shows the cross-correlation

$$E [ {X}_{1} {X}_{2}^{*} ]$$

of the two input signals X₁, X₂ with respect to the frequency. From the cross-correlation

$$E [ {X}_{1} {X}_{2}^{*} ]$$

and the auto-correlations [|X₁|²], E[|X₂|²] of the input signals X₁, X₂ of the microphones 18a, 18b, a complex-valued coherent transfer function R from the back microphone 18b to the front microphone 18a is calculated by

$$R = \frac{E [ {X}_{1} {X}_{2}^{*} ]}{{ρ}_{1} E [ {\vert {X}_{1} \vert}^{2} ] + ( 1 + {ρ}_{2} ) E [ {\vert {X}_{2} \vert}^{2} ]}$$

The transfer function R is determined by dividing the cross-correlation

$$E [ {X}_{1} {X}_{2}^{*} ]$$

by a weighted sum of the first auto-correlation E[|X₁|²] and the second auto-correlation E[|X₂|²]. R is not a normalized cross-correlation as defined in the literature, in which variances would be used in the denominator, but it is rather a transfer function estimate.

The weighted sum of the first auto-correlation E [|X₁|²] and the second auto-correlation E[|X₂|²] is determined by multiplying the first auto-correlation E[|X₁|²] with a first regularization coefficient ρ₁ and the second auto-correlation E[|X₂|²] with a second regularization coefficient ρ₂. The regularization coefficients ρ₁ and ρ₂ in the weighted sum may be fixed values and/or which may be tuned to suppress wind noise as strong as possible.

The transfer function R is determined by dividing the cross-correlation

$$E [ {X}_{1} {X}_{2}^{*} ]$$

by a weighted sum of the first auto-correlation E[|X₁|²] and the second auto-correlation E[|X₂|²].

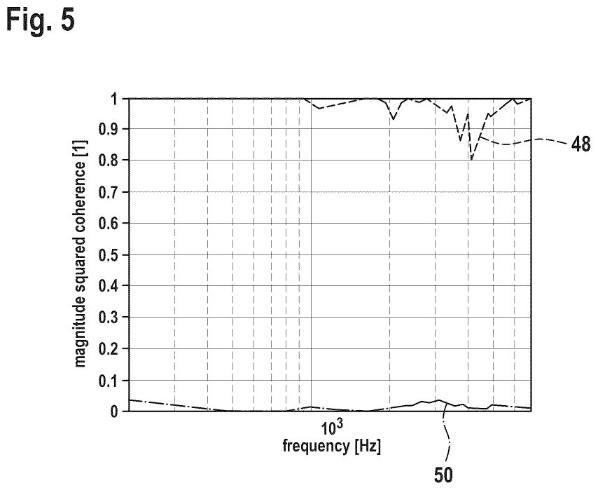

FIG. 5 shows curves 48, 50 with a magnitude of the squared coherence of the input signals X₁, X₂ from the microphones 18a, 18b. This magnitude is also provided by the transfer function R. The curve 48 shows the magnitude during speech, where the magnitude is near 1, and the curve 50 shows the magnitude during wind noise, where the magnitude is near 0. It can be seen that the transfer function R is a good indicator for detecting wind noise.

Returning to FIG. 2, the noise reduced signal Y₁, Y₂ are then determined by multiplying the first input signal X₁ and the second input signal X₂ with the transfer function R, from which, however, the phase may be removed and/or its magnitude may be adapted.

For this, a real-valued gain r=|R| and a phase factor R/r is computed from the complex-valued coherent transfer function R.

For determining the noise reduced signal Y₂, the gain r is limited from below to reduce artifacts to a limited gain r_{L}=max(r, r_{M}). The maximal attenuation r_{M} or the minimal gain r_{M} may be a fixed value and/or may be tuned to reduce artifacts as strong as possible.

The limited gain r_{L} is applied to the input signal X₂ of the back microphone 18b by multiplication.

Additionally, the phase factor R/r is multiplied to the input signal X₂ of the back microphone 18b to map the input signal X₂ to the front microphone 18a. As will be shown below, the phase factor R/r may provide the projection of the input signal X₂ from the back microphone 18b to the input signal X₁ of the front microphone 18a.

The result is a noise reduced signal Y₂.

For determining the noise reduced signal Y₁, the limited gain r_{L} is further limited from above to an attenuation gain r_{A}=min(r, r_{H}). For example, r_{H}=1. In such a way, the gain is limited to attenuation only and/or the projection from the back microphone 18b to the front microphone 18a may be removed for the most part.

The attenuation gain r_{A} is applied to the input signal X₁ of the back microphone 18b by multiplication, resulting in a noise reduced signal Y₁.

In general, a magnitude r of the transfer function R is limited from below with a minimal gain r_{L} before multiplication with the first input signal X₁ and/or the second input signal X₂.

For determining the first noise reduced signal Y₁, the magnitude r of the transfer function R is limited from below with a minimal gain r_{L} and limit from above with a maximal gain r_{H} before multiplication with the first input signal X₁.

For determining the second noise reduced signal Y₂, the magnitude r of the transfer function R is limited from below with a minimal gain r_{L}.

After that, the wind noise canceller 40 determines a mixed noise reduced signal Z by mixing the first noise reduced signal Y₁ and the second noise reduced signal Y₂. For this, the wind noise canceller 40 comprises a detector and mixer 44, which estimates which of the first input signal X₁ and the second input signal X₂ contains lesser wind noise.

The first noise reduced signal Y₁ and the second noise reduced signal Y₂ may be mixed by determining weights for the first noise reduced signal Y₁ and the second noise reduced signal Y₂ and summing the first noise reduced signal Y₁ and the second noise reduced signal Y₂ weighted with the weights.

For example, a weight w between 0 and 1 is determined and the noise reduced signal Y₁ and the noise reduced signal Y₂ are mixed with this weight.

Z=wY₁+(1−w)Y₂

The result is a wind noise reduced signal Z, which can be further processed by the hearing device 10. It is also possible that the weight w is solely 0 and 1.

It may be that the second noise reduced signal Y₂, i.e. the signal from the back microphone 18b is used as wind noise reduced signal Z. The detector and mixer 44 may provide a main mode, in which the weight w is 0 and a fallback mode, in which the weigh t w is 1. In the fallback mode, the first noise reduced signal Y₁, from the front microphone 18a is output as wind noise reduced signal Z.

Mixing and/or the fallback mode may be necessary, because the second noise reduced signal Y₂ from the back microphone 18b may not always be less affected by wind noise, when compared to the first noise reduced signal Y₁ from the front microphone 18a. When wind arrives directly from the rear, it may be that one can hear annoying click noise artifacts in the signal Y₂ from the back microphone 18b, which are not audible in the signal Y₁ from the front microphone 18a under the same conditions. One of the purposes of the detector and mixer 44 is to detect exactly these click noises and/or to trigger the fallback mode, in such cases.

The detector and mixer 44 determines a first power of the first input signal X₁ in at least a frequency band and a second power of the second input signal X₂ in at least the frequency band. The first power and the second power are functions over time and/or in the time domain. The detector and mixer 44 measures the front and the back microphone power in a certain frequency band, for example the sum over a range of specific frequency bins.

After that the detector and mixer 44 determines a power ratio by dividing the second power by the first power or vice versa. The power ratio is a function over time and/or in the time domain. Optionally, the power ratio is normalized using a constant factor and/or limited to the range of [0, 1]. The power ratio is then averaged into an averaged power ratio and after that is optionally smoothed. The result is compared to a threshold. When the result is higher (or alternatively lower) than a threshold, the weight w is set to 1. When the result is lower (or alternatively higher) than the threshold, the weight w is set to 0. Below the threshold, the default mode may be used and above the threshold, fallback mode is used, (or vice versa).

Averaging may be done with dual slope averaging. With dual slope averaging the peaks of the power ratio may be tracked. With dual slope averaging in an integration phase, the power ration may be integrated (or summed). The resulting signal ramps up or down in response to the input signal. In a de-integration phase after the integration phase, a reference signal may be applied to the integrated signal, and the integrated signal discharges at a known rate until it returns to zero. In dual slope averaging, integration and de-integration is performed two times.

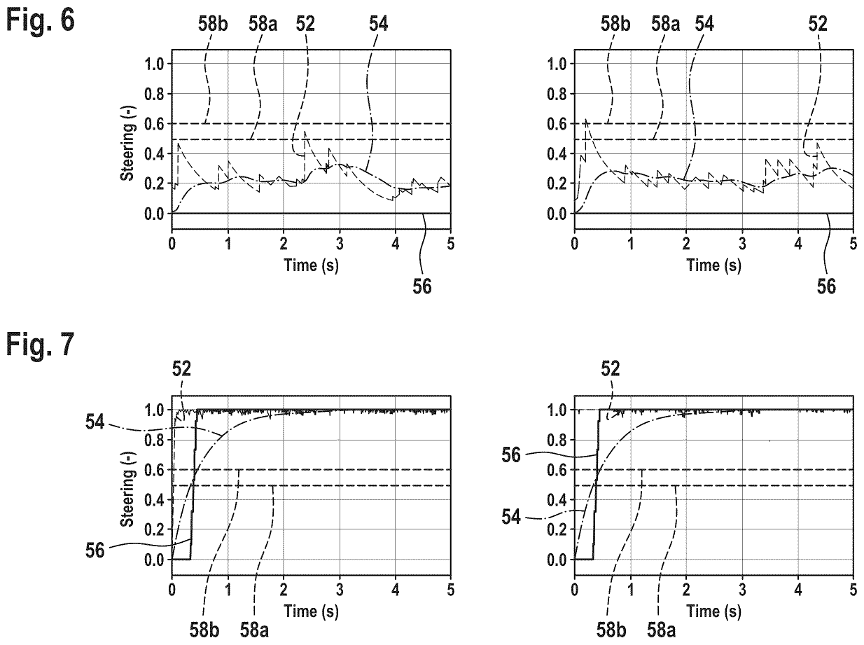

FIGS. 6 and 7 show diagrams with an averaged power ratio 52, which was determined by dual slope averaging of the power ratio of the input signals X₁ and X₂. FIG. 6 is an example with wind from the front and FIG. 7 is an example with wind from the back. The left-hand side panels show the curves for the left hearing device 10, i.e. for the left ear. The right-hand side panels show the curves for the right hearing device 10, i.e. for the right ear.

FIGS. 6 and 7 furthermore show the smoothed averaged power ratio 54 and the weight w, 56 over time.

In FIGS. 6 and 7 also an embodiment with a lower threshold 58a and an upper threshold 58b is shown. When the power ratio 54 is below the lower threshold 58a, then the weight w, 56 is 0. When the power ratio 54 is above the upper threshold 58b, then the weight w, 56 is 1. In between the thresholds, the weight w, 56 is between 0 and 1.

The noise reduced signal Z is then input into a sound processor 42 of the hearing device 10, which further processes the noise reduced signal Z into a further processed signal Z′. The further processed signal Z′ is output to the user of the hearing device 10 via the sound output device 32. The sound processor 42 may be adapted for frequency depending amplification, frequency shifting, frequency compressing, beam forming and/or noise cancelling.

To gain insight into the functionality of the coherent transfer function R such as defined above in context of wind noise cancelation, the following statistical model is assumed:

X₁=H₁S+N₁

X₂=H₂S+N₂

where X₁, X₂ are the frequency domain signals, H₁, H₂ are the transfer functions from the source to the front microphone 18a and the back microphone 18b, for example the respective head related transfer function depending on the location/direction of the source). S is the source signal and N₁, N₂ are the (wind) noise signals in the respective input signal X₁, X₂.

It is then assumed that the source signal S is independent of as well as uncorrelated and incoherent with respect to the wind noise signals N₁, N₂, i.e.,

$$E [ S {N}_{1}^{*} ] = 0 and E [ S {N}_{2}^{*} ] = 0 .$$

It is further assumed that the wind noise signals N₁, N₂ are also independent of as well as uncorrelated and incoherent with respect to each other, i.e.,

$$E [ {N}_{2} {N}_{1}^{*} ] = 0 .$$

Then, the correlation as used in the coherent transfer function R can be evaluated as follows:

$$E [ {X}_{1} {X}_{2}^{*} ] = E [ ( {H}_{1} S + {N}_{1} ) {( {H}_{2} S + {N}_{2} )}^{*} ] = {H}_{1} {H}_{2}^{*} E [ {\vert S \vert}^{2} ]$$

$$E [ {\vert {X}_{1} \vert}^{2} ] = E [ ( {H}_{1} S + {N}_{1} ) {( {H}_{1} S + {N}_{1} )}^{*} ] = {\vert {H}_{1} \vert}^{2} E [ {\vert S \vert}^{2} ] + E [ {\vert {N}_{1} \vert}^{2} ]$$

$$E [ {\vert {X}_{2} \vert}^{2} ] = E [ ( {H}_{2} S + {N}_{2} ) {( {H}_{2} S + {N}_{2} )}^{*} ] = {\vert {H}_{2} \vert}^{2} E [ {\vert S \vert}^{2} ] + E [ {\vert {N}_{2} \vert}^{2} ]$$

### Resulting in

$$R = \frac{{H}_{1} {H}_{2}^{*} E [ {\vert S \vert}^{2} ]}{{ρ}_{1} ( {\vert {H}_{1} \vert}^{2} E [ {\vert S \vert}^{2} ] + E [ {\vert {N}_{1} \vert}^{2} ] ) + ( 1 + {ρ}_{2} ) ( {\vert {H}_{2} \vert}^{2} E [ {\vert S \vert}^{2} ] + E [ {\vert {N}_{2} \vert}^{2} ] )}$$

or slightly reformulated

$$R = \frac{{H}_{1}}{{H}_{2}} \frac{{\vert {H}_{2} \vert}^{2} E [ {\vert S \vert}^{2} ]}{{ρ}_{1} ( {\vert {H}_{1} \vert}^{2} E [ {\vert S \vert}^{2} ] + E [ {\vert {N}_{1} \vert}^{2} ] ) + ( 1 + {ρ}_{2} ) ( {\vert {H}_{2} \vert}^{2} E [ {\vert S \vert}^{2} ] + E [ {\vert {N}_{2} \vert}^{2} ] )}$$

where the first factor

$$\frac{{H}_{1}}{{H}_{2}}$$

is a projection of the source signal S from X₂ to X₁ and the second term is a real-valued gain depending on the level of the source signal S at X₁ and X₂ and as well as the wind noise levels.

Removing the regularization by setting ρ₁=ρ₂=1 leads to

$$R \approx \frac{{H}_{1}}{{H}_{2}} \frac{{\vert {H}_{2} \vert}^{2} E [ {\vert S \vert}^{2} ]}{{\vert {H}_{2} \vert}^{2} E [ {\vert S \vert}^{2} ] + E [ {\vert {N}_{2} \vert}^{2} ]} = \frac{{H}_{1}}{{H}_{2}} \hat{W}$$

which is a combination of the projection

$$\frac{{H}_{1}}{{H}_{2}}$$

of the source signal S from X₂ to X₁ and a Wiener filter Ŵ at X₂. The Wiener filter Ŵ can be described by

$$\hat{W} = {arg}_{W} min E [ {‖ ( {H}_{2} S + {N}_{2} ) - {H}_{2} S ‖}_{2} ]$$

where the desired signal is H₂S and the noisy signal is H₂S+N₂ minimizing the Wiener filter Ŵ.

In summary, the coherent transfer function R can be decomposed into a projection

$$\frac{{H}_{0}}{{H}_{1}}$$

of the back microphone 18b to the front microphone 18a and a real-valued Wiener gain.

The projection

$$\frac{{H}_{0}}{{H}_{1}}$$

may be seen as a difference of the head-related transfer functions from the source to the back microphone 18b and to the front microphone 18a. This projection can be determined by calculating the phase or argument of the complex value R.

The Wiener gain can be seen as the coherent signal divided by the coherent and incoherent signal at the back microphone 18b, when assuming that the coherent signal is the target signal and the incoherent signal shall be suppressed. The Wiener gain can be determined by calculating the magnitude or absolute value of the complex value R.

While the embodiments described herein have been illustrated and described in detail in the drawings and foregoing description, such illustration and description are to be considered illustrative or exemplary and not restrictive; the invention is not limited to the disclosed embodiments. Other variations to the disclosed embodiments can be understood and effected by those skilled in the art and practicing the claimed invention from a study of the drawings, the disclosure, and the appended claims. In the claims, the word “comprising” does not exclude other elements or steps, and the indefinite article “a” or “an” does not exclude a plurality. A single processor or controller or other unit may fulfill the functions of several items recited in the claims. The mere fact that certain measures are recited in mutually different dependent claims does not indicate that a combination of these measures cannot be used to advantage. Any reference signs in the claims should not be construed as limiting the scope.

### LIST OF REFERENCE SYMBOLS

10 hearing device
12 behind-the-ear part
14 in-the-ear part
16 housing
18a front microphone
18b back microphone
20 computing device
22 battery
24 knob
26 connector
28 housing
30 connector
32 sound output device, loudspeaker
34 dome
36 cable
38 further sensor
40 wind noise canceller
42 sound processor
44 detector and mixer
X₁ first input signal
X₂ second input signal
Y₁ first noise reduced signal
Y₂ second noise reduced signal
Z mixed noise reduced signal
r_{L} limited gain
r_{A} attenuation gain
N further processed signal
46a auto-correlation of first input signal
46b auto-correlation of second input signal
46c cross-correlation of first and second input signal
48 magnitude of coherence during speech
50 magnitude of coherence during wind noise
52 averaged power ratio
54 smoothed averaged power ratio
56 weight
58a lower threshold
58b upper threshold

What is claimed is:

1. A method for wind noise reduction with a hearing device, the method comprising:
receiving a first input signal from a first microphone of the hearing device and a second input signal from a second microphone of the hearing device;
determining correlated components of the first input signal and the second input signal;
determining a noise reduced signal by dampening components in the first input signal different from the correlated components and/or by amplifying the correlated components in the first input signal.

2. The method of claim 1, further comprising:
determining a first noise reduced signal by dampening components in the first input signal different from the correlated components and/or by amplifying the correlated components in the first input signal;
determining a second noise reduced signal by dampening components in the second input signal different from the correlated components and/or by amplifying the correlated components in the second input signal;
determining a mixed noise reduced signal by mixing the first noise reduced signal and the second noise reduced signal.

3. The method of claim 2, further comprising:
mixing the first noise reduced signal and the second noise reduced signal by: determining weights for the first noise reduced signal and the second noise reduced signal; and
summing the first noise reduced signal and the second noise reduced signal weighted with the weights.

4. The method of claim 3, further comprising:
determining a first power of the first input signal in at least a frequency band and a second power of the second input signal in at least the frequency band;
determining a power ratio from the first power and the second power;
wherein the weights are determined from the power ratio.

5. The method of claim 4, further comprising:
averaging the power ratio into an averaged power ratio;
wherein the weights are determined from the averaged power ratio.

6. The method of claim 1, further comprising:
determining a first auto-correlation of the first input signal, a second auto-correlation of the second input signal and a cross-correlation between the first input signal and the second input signal;
determining a transfer function by dividing the cross-correlation by a weighted sum of the first auto-correlation and the second auto-correlation;
determining a noise reduced signal by multiplying the first input signal and/or the second input signal with the transfer function.

7. The method of claim 6,
wherein a magnitude of the transfer function is limited from below with a minimal gain before multiplication with the first input signal and/or the second input signal.

8. The method of claim 6, further comprising:
determining a first noise reduced signal by multiplying the first input signal with the transfer function, wherein a magnitude of the transfer function is limited from below with a minimal gain and limit from above with a maximal gain before multiplication with the first input signal;
determining a second noise reduced signal by multiplying the second input signal with the transfer function, wherein a magnitude of the transfer function is limited from below with a minimal gain.

9. The method of claim 6,
wherein the weighted sum of the first auto-correlation and the second auto-correlation is determined by multiplying the first auto-correlation with a first regularization coefficient and the second auto-correlation with a second regularization coefficient.

10. The method of claim 6,
wherein the cross-correlation, the first auto-correlation and second auto-correlation are averaged in the frequency domain.

11. The method of claim 1,
wherein the first microphone is a front microphone and the second microphone is a back microphone of the hearing device.

12. The method of claim 1, further comprising:
further processing the noise reduced signal into a further processed signal and outputting the further processed signal to a user of the hearing device;
wherein further processing comprises at least one of:
frequency depending amplification;
frequency shifting and/or frequency compressing;
beam forming;
noise cancelling.

13. A computer program for wind noise reduction with a hearing device, which, when being executed by a processor, is adapted to carry out the steps of the method of claim 1.

14. A hearing device, comprising:
a first microphone and a second microphone;
a sound output device;
a wind noise canceller;
a sound processor,
wherein the hearing device is adapted for performing the method of claim 1.
